(19) United States
(12) Patent Application Publication
(10) Pub. No.: US 2012/0046159 A1
(43) Pub. Date: Feb. 23, 2012

(54) METHOD FOR RECOVERY OF COBALT AND MANGANESE FROM SPENT COBALT-MANGANESE-BROMINE (CMB) CATALYST AND METHOD FOR PRODUCING CMB CATALYST INCLUDING THE RECOVERY METHOD

(76) Inventors: Shun Myung SHIN, Daejeon (KR); Sung Ho Ju, Jinju-si (KR); Jin Gu Kang, Daejeon (KR); Han Kwon Chang, Daejeon (KR); Jeong Soo Sohn, Daejeon (KR)

(21) Appl. No.: 13/211,063

(22) Filed: Aug. 16, 2011

(30) Foreign Application Priority Data
Aug. 17, 2010 (KR) 10-2010-0079398

(51) Int. Cl. B01J 27/128; B01J 31/04

(52) U.S. Cl. 502/169; 502/229

(57) ABSTRACT

Disclosed is a method for recovering cobalt and manganese from a spent cobalt-manganese-bromine (CMB) catalyst. The method includes (a) continuously leaching a spent CMB catalyst with sulfuric acid, (b) separating the leachate into a solution and a residue, (c) extracting the solution with a solvent, and (d) washing the extract with water. According to the method, high-purity cobalt and manganese can be recovered in high yield from a spent CMB catalyst while minimizing the amount of impurities. Further disclosed is a method for producing a CMB liquid catalyst from the extract containing cobalt and manganese obtained by the recovery method.

### BACKGROUND OF THE INVENTION

1. Field of the Invention

The present invention relates to a method for the recovery of cobalt and manganese from a spent cobalt-manganese-bromine (CMB) catalyst and a method for producing a CMB catalyst including the recovery method. More specifically, the present invention relates to a method for the recovery of cobalt and manganese from a spent CMB catalyst through a series of steps including continuous leaching with sulfuric acid, solid-liquid separation, solvent extraction and water washing, and a method for producing a CMB liquid catalyst from an extract containing cobalt and manganese obtained by the recovery method.

2. Description of the Related Art

CMB liquid catalysts consisting of cobalt, manganese and bromine are used for the catalytic oxidation of para-xylene (PX), a petrochemical, to terephthalic acid (TPA). TPA is a raw material of products indispensable to our daily life such as polyester fibers, polyethylene terephthalate (PET) bottles, films, paints and tire cords. South Korea, a major TPA supplier, produced 5.5 million metric tons of TPA in 2006, making up about 21% of the global TPA production capacity (26 million tons). The market for CMB catalysts is also estimated to be very large. Therefore, recovery of Co and Mn from spent CMB catalysts is gaining importance for the production of CMB catalysts from the viewpoint of economic efficiency.

### SUMMARY OF THE INVENTION

The present inventors have earnestly and intensively conducted research to develop an efficient method for the recovery of cobalt and manganese from spent CMB catalysts. As a result, the present inventors have found that cobalt and manganese almost free of impurities can be recovered in high purity from spent CMB catalyst samples through a series of steps including continuous leaching with sulfuric acid, solid-liquid separation, solvent extraction and water washing. The present inventors have also found that CMB liquid catalysts can be produced from extracts containing the recovered cobalt and manganese. The present invention has been accomplished based on these findings.

Now, therefore, it is an object of the present invention to provide a method for selectively recovering cobalt and manganese from a spent CMB catalyst.

It is another object of the present invention to provide a method for producing a CMB liquid catalyst from an extract containing cobalt and manganese obtained by the recovery method.

In accordance with one aspect of the present invention, there is provided a method for recovering cobalt and manganese from a spent cobalt-manganese-bromine (CMB) catalyst, the method including (a) continuously leaching a spent CMB catalyst with sulfuric acid, (b) separating the leachate into a solution and a residue, (c) extracting the solution with a solvent, and (d) washing the extract with water.

The continuous leaching in step (a) may be carried out to remove one or more impurities selected from the group consisting of Fe, Pb, Cu and Zn. In step (a), the pH may be adjusted to 5.5 to 6, which is suitable for selective extraction of cobalt and manganese.

The solvent used in step (c) may be selected from the group consisting of di-2-ethylhexyl phosphoric acid, 2-ethylhexyl phosphonic acid, mono-2-ethylhexyl ester, di-2,4,4-trimethylpentyl phosphinic acid, di-2-ethylhexyl phosphinic acid, di-2,4,4-trimethylpentyl dithiophosphinic acid, di-2,4,4-trimethylpentyl monothiophosphinic acid, and mixtures thereof.

The solvent may be saponified with an alkaline solution before use.

The degree of saponification of the solvent may be from 30 to 50%.

In accordance with another aspect of the present invention, there is provided a method for producing a cobalt-manganese-bromine (CMB) liquid catalyst from a spent CMB catalyst, the method including (e) adding a hydrobromic acid (HBr) solution to the extract obtained in the recovery method of cobalt and manganese, followed by back extraction to obtain a CMB stripping solution, and (f) adding a cobalt salt and a manganese salt to the CMB stripping solution to produce a CMB liquid catalyst having appropriate cobalt, manganese and bromine concentrations.

The extract used in step (e) is one obtained in the extraction step (c) (i.e. a loaded organic obtained after the extraction).

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a process chart showing a method for producing a CMB liquid catalyst according to an embodiment of the present invention;

FIG. 2 shows results of 2 step counter-current simulation extraction of Co using 30% saponified 0.88 M Cyanex 272;

FIG. 3 shows results of 2 step counter-current simulation extraction of Mn using 30% saponified 0.88 M Cyanex 272;

FIG. 4 shows results of 2 step counter-current simulation extraction of Co using 40% saponified 0.88 M Cyanex 272;

FIG. 5 shows results of 2 step counter-current simulation extraction of Mn using 40% saponified 0.88 M Cyanex 272;

FIG. 6 shows results of 2 step counter-current simulation extraction of Co using 40% saponified 1.17 M Cyanex 272;

FIG. 7 shows results of 2 step counter-current simulation extraction of Mn using 40% saponified 1.17 M Cyanex 272;

FIG. 8 shows results of 3 step counter-current simulation extraction of Co using 30% saponified 1.17 M Cyanex 272; and

FIG. 9 shows results of 3 step counter-current simulation extraction of Mn using 30% saponified 1.17 M Cyanex 272.

### DETAILED DESCRIPTION OF THE INVENTION

In one aspect, the present invention is directed to a method for recovering cobalt and manganese from a spent cobalt-manganese-bromine (CMB) catalyst, the method including (a) continuously leaching a spent CMB catalyst with sulfuric acid, (b) separating the leachate into a solution and a residue, (c) extracting the solution with a solvent, and (d) washing the extract with water.

The present invention will now be described in detail with reference to the accompanying drawings.

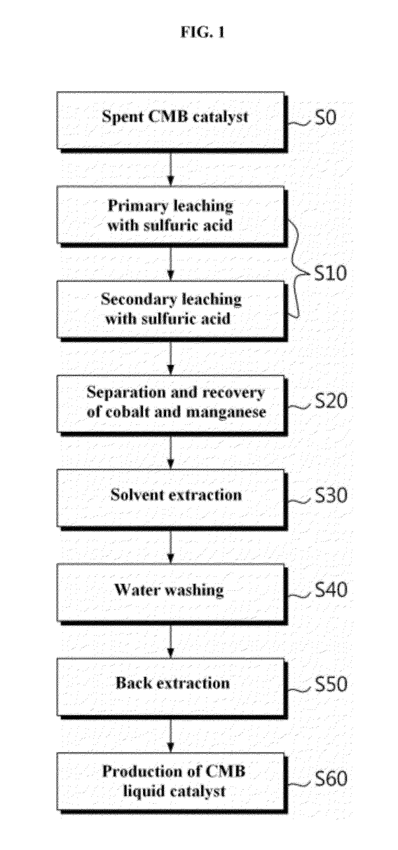

Referring to FIG. 1, first, a spent CMB catalyst is prepared (S0). The spent CMB catalyst contains valuable metals, such as cobalt and manganese, and large amounts of other impurities. In step (a), the spent CMB catalyst is continuously leached with sulfuric acid to control the amounts of impurities such as Fe, Pb, Cu and Zn present therein (S10).

In step (b), the leachate is separated into a solution and a residue (S20). This solid-liquid separation may be carried out using a filter press or filter paper. Those skilled in the art can easily select suitable means for the solid-liquid separation.

In step (c), the solution is extracted with a solvent (S30). The solvent is selected from the group consisting of di-2-ethylhexyl phosphoric acid, 2-ethylhexyl phosphonic acid, mono-2-ethylhexyl ester, di-2,4,4-trimethylpentyl phosphinic acid, di-2-ethylhexyl phosphinic acid, di-2,4,4-trimethylpentyl dithiophosphinic acid, di-2,4,4-trimethylpentyl monothiophosphinic acid, and mixtures thereof. Bis(2,4,4-trimethylpentyl)phosphinic acid is preferred.

It is preferred to saponify the solvent with an alkaline solution before use. The degree of saponification of the solvent may be from 30 to 50%, preferably 40 to 50%. This saponification is advantageous in increasing the recovery rate of cobalt and manganese while minimizing the amount of impurities.

The saponified solvent is used to adjust the pH to a preferred range necessary for selective extraction of Co and Mn.

For example, the extraction reaction of cobalt and manganese with bis(2,4,4-trimethylpentyl)phosphinic acid (Cyanex 272, Cytec Inc., USA) as the solvent is depicted in Reaction 1:

X²⁺2HR ⇄XR₂+2H⁺ (1)

wherein X is Co or Mn and R is C₁₆H₃₄PO₂⁻.

As the reaction proceeds, the pH of the solution separated in step (b) decreases. To adjust the pH to a preferred range, the solvent is saponified with an alkaline solution such as a NaOH or NH₄OH solution. This saponification is depicted in Reaction 2:

HR+NaOH(or NH₄OH)⇄NaR(or NH₄R)+H₂X (2)

The cobalt or manganese ion reacts with the saponified solvent, as depicted in Reaction 3:

X²⁺+NaR(or NH₄R)⇄2Na⁺(or 2NH₄⁺)

In Reaction 2, the H⁺ ion of the solvent is replaced by the Na⁺ or NH₄⁺ ion.

In step (d), the extract is washed with water (S40). The extract can be washed with distilled water at 50 to 70° C. within 1 min when the organic/aqueous (OA) ratio is from 10:1 to 1:10. Preferably, the extract is washed with distilled water at 60° C. when the organic/aqueous (OA) ratio is 2:1.

In another aspect, the present invention is directed to a method for producing a cobalt-manganese-bromine (CMB) liquid catalyst from a spent CMB catalyst, the method including (e) adding a hydrobromic acid (HBr) solution to the extract obtained in the recovery method of cobalt and manganese, followed by back extraction to obtain a CMB stripping solution, and (f) adding a cobalt salt and a manganese salt to the CMB stripping solution to produce a CMB liquid catalyst having appropriate cobalt, manganese and bromine concentrations.

The term ‘extract’ used herein is interchangeably used with the term ‘solution extracted with Cyanex 272’ or ‘extraction solution.’ The extract obtained in step (c) or (d) may also be expressed a ‘loaded organic.’

The CMB stripping solution obtained by back extraction (stripping) may not be suitable for use as a CMB liquid catalyst because the composition the CMB stripping solution do not reach that of the CMB liquid catalyst. In step (f), a cobalt salt and a manganese salt at appropriate concentrations are added to and mixed with the stripping solution to produce a CMB liquid catalyst in which the components are present in an optimal ratio.

The cobalt salt may be cobalt bromide (CoBr₂) and the manganese salt may be manganese bromide (MnBr₂) or manganese acetate (Mn(OAc)₂). The amounts of the cobalt and manganese salts added to the stripping solution may be determined depending on the cobalt, manganese and bromine contents of the CMB stripping solution. The cobalt and manganese salts are added in amounts such that the molar ratio of Co, Mn and Br in the CMB liquid catalyst is 0.51:1.09:1.91.

Hereinafter, the present invention is explained in more detail with reference to the following examples. These examples are provided for illustrative purposes only. Those skilled in the art will readily recognize and appreciate that the examples are not intended to limit the scope of the present invention and are encompassed within the spirit of the present invention.

### EXAMPLES

### Experimental Methods

Leaching and Solvent Extraction—Preparation of Feed Solution

A spent CMB catalyst sample was prepared to have the composition indicated in Table 1.

TABLE 1

| | Co | Mn | Ca | Mg | Zn | Cu | Fe | Pb | Cr |
|---|---|---|---|---|---|---|---|---|---|
| Com- | 30,300 | 13,960 | 282.3 | 57.4 | 5.96 | 2.3 | 19.4 | 4.1 | 4.2 |
| position | | | | | | | | | |
| of spent | | | | | | | | | |
| CMB | | | | | | | | | |
| catalyst | | | | | | | | | |
| (mg/L) | | | | | | | | | |

The spent CMB catalyst sample was continuously leached with sulfuric acid until the pH of the leachate reached 6.15 to prepare a feed solution in which the contents of impurities such as Fe, Pb, Cu and Zn was controlled.

Solvent Extraction of Co and Mn with Cyanex 272

Co and Mn were recovered and separated from the feed solution using a solvent.

As the solvent, bis(2,4,4-trimethylpentyl)phosphinic acid (Cyanex 272, Cytec Inc.), which is an extracting agent known in the art, was purchased and used without further purification. Cyanex 272 has a molecular weight of 290, a density of 142 cp (25° C.), a specific gravity of 0.92 gm/cc (24° C.) and a purity of 85%. Cyanex 272 has a molecular formula of C₁₆H₃₄PO₂H and is structurally represented by the following formula:

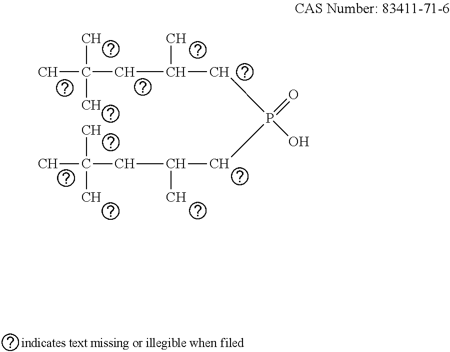

Kerosene (b.p. 180-270° C.) purchased from Jensei Chemicals (Japan) was used as a diluent.

FIG. 1 is a process chart showing the method for producing a CMB liquid catalyst according to the present invention.

Referring to FIG. 1, the spent CMB catalyst sample was subjected to two-step leaching with sulfuric acid (S10) to control the amount of impurities present therein. The leachate was separated into a solution and a residue (S20). 0.88 M Cyanex 272 (0/A=4) and 1.17 M Cyanex 272 (0/A=3) were used for solvent extraction (S30). The solvents were saponified with an alkaline solution to achieve high extraction efficiency. The degrees of saponification of the solvents were about 30-50%. After extraction, a loaded organic was obtained. An HBr solution was added to strip the loaded organic (back extraction) to prepare an aqueous CMB solution (S50). Cobalt acetate or cobalt bromide hydrate and manganese acetate or manganese bromide hydrate were added to the CMB stripping solution to produce a CMB liquid catalyst having the same composition as that used in industrial fields (S60). 2 step counter-current simulation extraction experiments were conducted to identify more efficient Co extraction behavior.

### Example 1

Leaching experiments were conducted using 1 M sulfuric acid at 200-250 rpm, 60° C. and a solid-liquid ratio of 1:10 for 120 min. Table 2 shows the compositions of the leachates (mg/L) after continuous leaching of the spent CMB catalyst with sulfuric acid. The impurities were controlled by pH adjustment.

TABLE 2

| Feed | Co | Mn | Ca | Mg | Zn | Cu | Fe | Pb | Cr | pH |
|---|---|---|---|---|---|---|---|---|---|---|
| Leachate after | 30,090 | 13,160 | 289.1 | 55.4 | 7.5 | 10 | 4 | 1.7 | 3.7 | 0.89 |
| primary leaching with | | | | | | | | | | |
| sulfuric acid | | | | | | | | | | |
| Leachate after | 34,280 | 15,767 | 374.3 | 64.4 | 5.7 | 8 | 2.4 | 4.7 | 0 | 6.15 |
| secondary leaching | | | | | | | | | | |
| with sulfuric acid | | | | | | | | | | |

The results in Table 2 show completion removal of Cr after continuous leaching.

### Example 2

### Extractions for Separation and Recovery of Co and Mn with Solvents at Different Concentrations and Degrees of Saponification, and Experimental Results Thereof

1. Extraction Experiments of Secondary Leachate with 30%, 40% and 50% Saponified 0.88 M Cyanex 272 Solvents

Experiments for selective extraction of Co and Mn from the secondary leachate were conducted using 0.88 M Cyanex 272 solvents saponified with a NaOH solution. The solvents had different degrees of saponification of 30%, 40% and 50%. All solvent extraction experiments were conducted at 25° C. and an O/A of 4 (40 ml:10 ml). The leachate was extracted once with shaking for 5 min.

Table 3 shows the composition of the feed solution.

TABLE 3

| | Co | Mn | Ca | Mg | Zn | Cu | Fe | Pb | pH |
|---|---|---|---|---|---|---|---|---|---|
| Leachate | 34,280 | 15,767 | 349 | 64.4 | 5.7 | 8 | 2.4 | 4.7 | 6.15 |
| after | | | | | | | | | |
| secondary | | | | | | | | | |
| leaching | | | | | | | | | |
| with sulfuric | | | | | | | | | |
| acid (mg/L) | | | | | | | | | |

Table 4 shows the compositions of raffinates (mg/L) remaining after solvent extraction.

TABLE 4

| Degree | | | | | | | | | |
|---|---|---|---|---|---|---|---|---|---|
| of saponification | Co | Mn | Ca | Mg | Zn | Cu | Fe | Pb | pH |
| 30% | 15,666 | 9,266.8 | 345 | 56 | 0.05 | 3.1 | 2.8 | 1.0 | 4.06 |
| 40% | 8,641 | 4,313.6 | 305.1 | 48.7 | 0.1 | 1.8 | 1.0 | 0.39 | 4.37 |
| 50% | 3,482 | 3,912.3 | 266.5 | 37.7 | 0 | 0.35 | 0.7 | 0 | 4.87 |

The extraction rates (%) of the valuable metals depending on the degrees of saponification were calculated from the results in Tables 3 and 4. The results are shown in Table 5.

TABLE 5

| Degree | | | | | | | | | |
|---|---|---|---|---|---|---|---|---|---|
| of | | | | | | | | | |
| sapon- | | | | | | | | | |
| ification | Co | Mn | Ca | Mg | Zn | Cu | Fe | Pb | pH |
| 30% | 55.1 | 41.2 | 1.1 | 13 | 99.1 | 61.3 | −16.7 | 78.7 | 4.06 |
| 40% | 74.8 | 72.6 | 12.6 | 24.3 | 98.2 | 77.5 | 58.3 | 91.7 | 4.37 |
| 50% | 89.8 | 75.2 | 23.6 | 41.9 | 100 | 95.6 | 70.8 | 100 | 4.87 |

As for the 30% saponified 0.88 M Cyanex 272, the extraction rates of Co and Mn were 55.1% and 41.2%, respectively. As for the 40% saponified 0.88 M Cyanex 272, the extraction rates of Co and Mn were 74.8% and 72.6%, respectively. As for the 50% saponified 0.88 M Cyanex 272, the extraction rates of Co and Mn were 89.8% and 75.2%, respectively.

2. Extraction Experiments of Secondary Leachate with 30%, 40% and 50% Saponified 1.17 M Cyanex 272 Solvents

Experiments for selective extraction of Co and Mn from the secondary leachate were conducted using 1.17 M Cyanex 272 solvents saponified with a NaOH solution. The solvents had different degrees of saponification of 30%, 40% and 50%. All solvent extraction experiments were conducted at 25° C. and an O/A of 3 (30 ml:10 ml). The leachate was extracted once with shaking for 5 min.

Table 6 shows the composition of the feed solution.

TABLE 6

| | Co | Mn | Ca | Mg | Zn | Cu | Fe | Pb | pH |
|---|---|---|---|---|---|---|---|---|---|
| Leachate | 34,280 | 15,767 | 374.3 | 64.4 | 5.7 | 8 | 2.4 | 4.7 | 6.15 |
| after | | | | | | | | | |
| secondary | | | | | | | | | |
| leaching | | | | | | | | | |
| with sulfuric | | | | | | | | | |
| acid (mg/L) | | | | | | | | | |

Table 7 shows the composition of raffinates (mg/L) remaining after solvent extraction.

TABLE 7

| Degree of | | | | | | | | | |
|---|---|---|---|---|---|---|---|---|---|
| sapon- | | | | | | | | | |
| ification | Co | Mn | Ca | Mg | Zn | Cu | Fe | Pb | pH |
| 30% | 19,776 | 4596.7 | 332.1 | 58.1 | 3.4 | 3.9 | 1.6 | 1.9 | 4.02 |
| 40% | 12,729 | 2211.1 | 325.6 | 54.6 | 2.0 | 3.1 | 1.9 | 1.0 | 4.32 |
| 50% | 6,312.1 | 820.1 | 309.7 | 49.6 | 4.1 | 1.3 | 1.0 | 0.3 | 4.69 |

The extraction rates (%) of the valuable metals depending on the degrees of saponification were calculated from the results in Tables 6 and 7. The results are shown in Table 8.

TABLE 8

| Degree | | | | | | | | | |
|---|---|---|---|---|---|---|---|---|---|
| of | | | | | | | | | |
| sapon- | | | | | | | | | |
| ification | Co | Mn | Ca | Mg | Zn | Cu | Fe | Pb | pH |
| 30% | 42.3 | 70.8 | 11.3 | 9.7 | 40.3 | 50.3 | 32.1 | 58.9 | 4.02 |
| 40% | 62.9 | 86.0 | 13.0 | 15.2 | 64.9 | 61.3 | 20.8 | 78.9 | 4.32 |
| 50% | 81.6 | 94.8 | 17.4 | 23.0 | 28.1 | 83.4 | 58.0 | 93.6 | 4.69 |

As for the 30% saponified 1.17 M Cyanex 272, the extraction rates of Co and Mn were 42.3% and 70.8%, respectively. As for the 40% saponified 1.17 M Cyanex 272, the extraction rates of Co and Mn were 62.9% and 86.0%, respectively. As for the 50% saponified 1.17 M Cyanex 272, the extraction rates of Co and Mn were 81.6% and 94.8%, respectively. The extraction rates of Co and Mn tended to increase with increasing degree of saponification.

2 Step Counter-Current Simulation Extraction Experiments of the Solutions

1. 2 Step Counter-Current Simulation Extraction Experiments of Secondary Leachate with 30%, 40% and 50% Saponified 0.88 M Cyanex 272 Solvents

2 step counter-current simulation experiments for selective extraction of Co and Mn from the leachate were conducted using 0.88 M Cyanex 272 solvents saponified with a NaOH solution. The solvents had degrees of saponification of 30%, 40% and 50%. All solvent extraction experiments were conducted at 25° C. and an O/A of 4 (40 ml:10 ml). The leachate was extracted with shaking for 5 min.

Table 9 shows the results of the 2 step counter-current simulation extraction using the 30% saponified solvent.

TABLE 9

| Loading | Co | Mn | Ca | Mg | Zn | Cu | Fe | Pb | pH |
|---|---|---|---|---|---|---|---|---|---|
| Raffinate after first | 41,245.4 | 6,834.4 | 752.3 | 161.1 | 0.52 | 0.8 | 2.14 | 3.45 | 3.57 |
| extraction (mg/L) | | | | | | | | | |
| Raffinate after second | 35.56 | 0.184 | 0 | 2.43 | 0.94 | 0 | 0.78 | 0 | 5.43 |
| extraction (mg/L) | | | | | | | | | |

Table 10 shows the extraction rates (%) of the valuable metals after the 2 step counter-current simulation extraction using the 30% saponified solvent.

TABLE 10

| Loading | Co | Mn | Ca | Mg | Zn | Cu | Fe | Pb |
|---|---|---|---|---|---|---|---|---|
| First | −20.3 | 56.7 | −115 | 150 | 90.8 | 99.9 | 10.8 | 25.9 |
| extraction (%) | | | | | | | | |
| Second | 99.9 | 99.9 | 100 | 96.2 | 83.5 | 100 | 67.5 | 100 |
| extraction (%) | | | | | | | | |

As can be seen from the results in Tables 9 and 10, the extraction rates of Co and Mn were all 99.9% when the 30% saponified 0.88 M Cyanex 272 was used for the 2 step counter-current simulation extraction. The extraction rates of Co and Mn by the first extraction were −20.3% and 56.7%, respectively. FIG. 2 shows the Co extraction results when the 30% saponified 0.88 M Cyanex 272 was used, and FIG. 3 shows the Mn extraction results when the 30% saponified 0.88 M Cyanex 272 was used.

Tables 11 shows the results of the 2 step counter-current simulation extraction using the 40% saponified solvent.

TABLE 11

| Loading | Co | Mn | Ca | Mg | Zn | Cu | Fe | Pb | pH |
|---|---|---|---|---|---|---|---|---|---|
| Raffinate after first | 30,586 | 4,460 | 679.43 | 144.5 | 1.0 | 0.62 | 1.44 | 2.62 | 3.88 |
| extraction (mg/L) | | | | | | | | | |
| Raffinate after second | 0.174 | 0.176 | 0 | 0 | 0.08 | 0 | 0.56 | 0 | 6.65 |
| extraction (mg/L) | | | | | | | | | |

Table 12 shows the extraction rates (%) of the valuable metals after the 2 step counter-current simulation extraction using the 40% saponified solvent.

TABLE 12

| Loading | Co | Mn | Ca | Mg | Zn | Cu | Fe | Pb |
|---|---|---|---|---|---|---|---|---|
| First | 10.8 | 71.7 | −94 | −124.5 | 82.45 | 90 | 40 | 44.3 |
| extraction | | | | | | | | |
| (%) | | | | | | | | |
| Second | 99.9 | 99.9 | 100 | 100 | 98.6 | 100 | 76.7 | 100 |
| extraction | | | | | | | | |
| (%) | | | | | | | | |

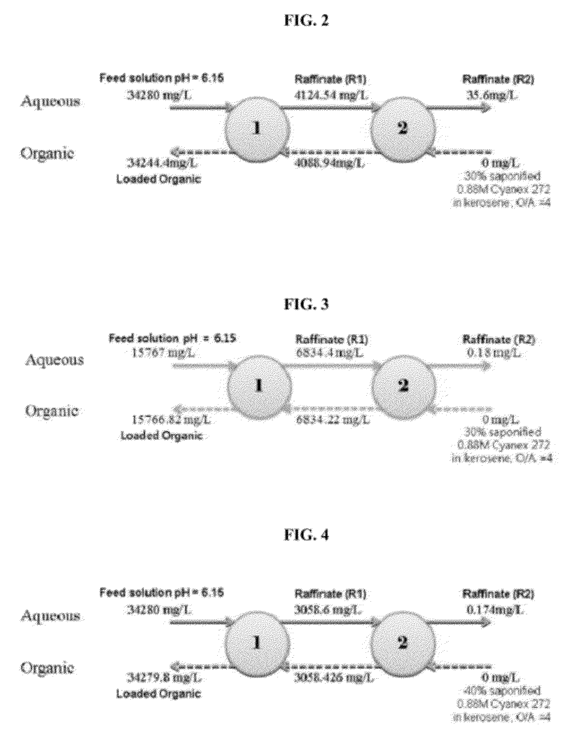

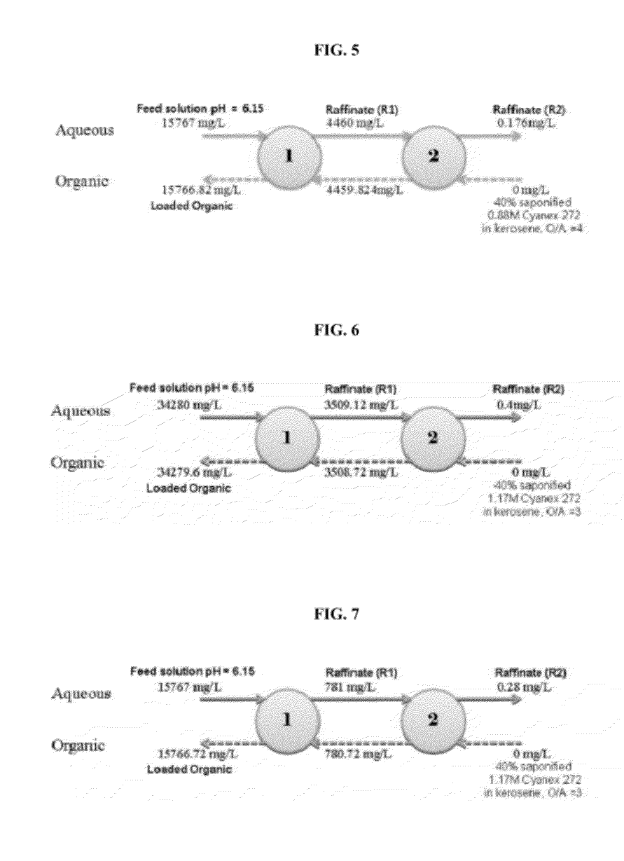

As can be seen from the results in Tables 11 and 12, the extraction rates of Co and Mn were all 99.9% when the 40% saponified 0.88 M Cyanex 272 was used for the 2 step counter-current simulation extraction. The extraction rates of Co and Mn by the first extraction were 10.8% and 71.7%, respectively. The Co and Mn contents of the final raffinate were 0.174 mg/L and 0.176 mg/L, respectively. FIG. 4 shows the Co extraction results when the 40% saponified 0.88 M Cyanex 272 was used, and FIG. 5 shows the Mn extraction results when the 40% saponified 0.88 M Cyanex 272 was used.

2. 2 Step Counter-Current Simulation Extraction Experiments of Leachate with 40% Saponified 1.17 M Cyanex 272

Table 13 shows the results of the 2 step counter-current simulation extraction using the 40% saponified solvent.

TABLE 13

| Loading | Co | Mn | Ca | Mg | Zn | Cu | Fe | Pb | pH |
|---|---|---|---|---|---|---|---|---|---|
| Raffinate after first | 3,509.1 | 780.97 | 707.5 | 120.7 | 2.13 | 0.682 | 1.5 | 2.5 | 3.62 |
| extraction (mg/L) | | | | | | | | | |
| Raffinate after second | 0.41 | 0.28 | 0 | 0 | 0.18 | 0 | 0.53 | 0 | 6.57 |
| extraction (mg/L) | | | | | | | | | |

Table 14 shows the extraction rates (%) of the valuable metals after the 2 step counter-current simulation extraction using the 40% saponified solvent.

TABLE 14

| Loading | Co | Mn | Ca | Mg | Zn | Cu | Fe | Pb |
|---|---|---|---|---|---|---|---|---|
| First | 89.8 | 95 | −108.5 | −87.5 | 62.6 | 99.9 | 37.5 | 46.8 |
| extraction | | | | | | | | |
| (%) | | | | | | | | |
| Second | 99.9 | 99.9 | 100 | 100 | 96.8 | 100 | 77.9 | 100 |
| extraction | | | | | | | | |
| (%) | | | | | | | | |

As can be seen from the results in Tables 13 and 14, the extraction rates of Co and Mn were all 99.9% when the 40% saponified 1.17 M Cyanex 272 was used for the 2 step counter-current simulation extraction. The extraction rates of Co and Mn by the first extraction were 89.8% and 95%, respectively. FIG. 6 shows the Co extraction results when the 40% saponified 1.17 M Cyanex 272 was used, and FIG. 7 shows the Mn extraction results when the 40% saponified 1.17 M Cyanex 272 was used.

3. 3 Step Counter-Current Simulation Extraction Experiments of Leachate with 30% Saponified 1.17 M Cyanex 272

3 step counter-current simulation extraction experiments were conducted using the 30% saponified solvent because complete extraction of Co and Mo was not achieved by the 2 step counter-current simulation extraction experiments using the 30% saponified solvent.

Table 15 shows the results of the 3 step counter-current simulation extraction using the 30% saponified solvent.

TABLE 15

| Loading | Co | Mn | Ca | Mg | Zn | Cu | Fe | Pb | pH |
|---|---|---|---|---|---|---|---|---|---|
| Raffinate after first | 33,645.4 | 10,515.3 | 452.1 | 72.1 | 0.5 | 0.3 | 0.4 | 3.57 | 3.61 |
| extraction (mg/L) | | | | | | | | | |
| Raffinate after second | 29,873.4 | 9,266.8 | 676.2 | 170.4 | 1.4 | 0.7 | 0.2 | 2.24 | 3.76 |
| extraction (mg/L) | | | | | | | | | |
| Raffinate after third | 0.28 | 0.21 | 0 | 0 | 0 | 0 | 0.8 | 0 | 6.46 |
| extraction (mg/L) | | | | | | | | | |

Table 16 shows the extraction rates (%) of the valuable metals after the 3 step counter-current simulation extraction using the 30% saponified solvent.

TABLE 16

| Loading | Co | Mn | Ca | Mg | Zn | Cu | Fe | Pb |
|---|---|---|---|---|---|---|---|---|
| First | 1.9 | 41.2 | −20.7 | −12.0 | 91.4 | 99.6 | 84.2 | 24 |
| extraction | | | | | | | | |
| (%) | | | | | | | | |
| Second | 12.9 | 33.3 | −80.6 | −164.7 | 75.4 | 99.1 | 90.4 | 52.3 |
| extraction | | | | | | | | |
| (%) | | | | | | | | |
| Third | 99.9 | 99.9 | 100 | 100 | 100 | 100 | 65.4 | 100 |
| extraction | | | | | | | | |
| (%) | | | | | | | | |

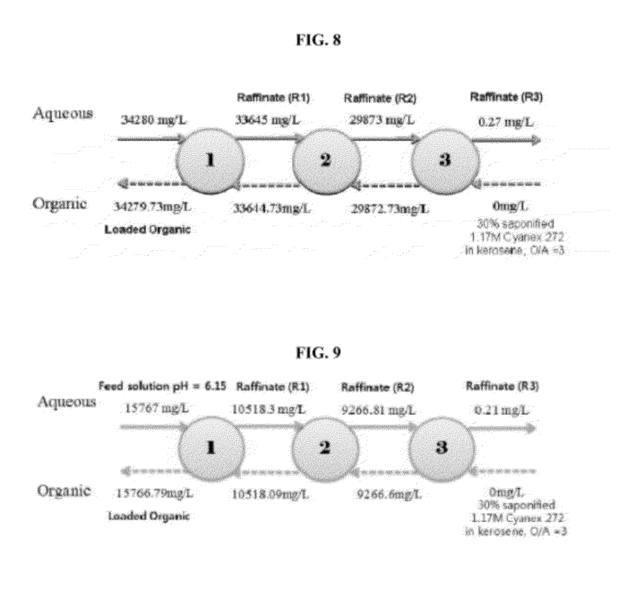

As can be seen from the results in Tables 15 and 16, the extraction rates of Co and Mn were all 99.9% when the 30% saponified 1.17 M Cyanex 272 was used for the 3 step counter-current simulation extraction. The extraction rates of Co and Mn by the first extraction were 1.9% and 41.2%, respectively. The Co and Mn contents of the final raffinate were 0.27 mg/L and 0.21 mg/L, respectively. FIG. 8 shows the Co extraction results when the 30% saponified 1.17 M Cyanex 272 was used, and FIG. 9 shows the Mn extraction results when the 30% saponified 1.17 M Cyanex 272 was used.

### Example 3

### Production of CMB Liquid Catalysts from the Stripping Solutions

CMB liquid catalysts were produced from the CMB stripping solutions. Table 17 shows the CMB specification and the compositions of the stripping solutions (g/L), which are intermediates of CMB liquid catalysts. The Br concentrations were measured by ion chromatography.

TABLE 17

| | Co | Mn | Br | Ca | | Mg | | Na | | Zn | | Cu | | Fe | | Pb | |
|---|---|---|---|---|---|---|---|---|---|---|---|---|---|---|---|---|---|
| CMB spec. | 30 | 60 | 153 | <10 | mg | <10 | mg | <10 | mg | <10 | mg | <10 | mg | <10 | mg | <10 | mg |
| 0.88M 30% | 14.4 | 10.9 | 174 | 0 | | 0 | | 1.2 | mg | 2.2 | mg | 4.2 | mg | 1.4 | mg | 0.2 | mg |
| (O/A = 4) | | | | | | | | | | | | | | | | | |
| 1.17M 40% | 12.4 | 13.2 | 164 | 0 | | 0 | | 1.7 | mg | 2.5 | mg | 3.7 | mg | 1.0 | mg | 0.4 | mg |
| (O/A = 3) | | | | | | | | | | | | | | | | | |

Cobalt bromide, manganese bromide and manganese acetate were added to each of the stripping solutions to produce CMB liquid catalysts with controlled Co, Mn and Br concentrations. The amounts of the cobalt and manganese salts necessary for the production of the CMB catalysts are shown in Table 18.

TABLE 18

| | Number of moles of metals in the | | | Necessary number of moles of cobalt | |
|---|---|---|---|---|---|
| | solution | | | and manganese salts | |
| Mol | Co | Mn | Br | Co(OAc)₂ | Mn(OAc)₂ |
| CMB spec. | 0.51 | 1.09 | 1.91 | — | — |
| 0.88M 30% (O/A = 4) | 0.24 | 0.20 | 2.18 | 0.34 | 1.04 |
| 1.17M 40% (O/A = 3) | 0.21 | 0.24 | 2.05 | 0.37 | 0.83 |

As can be seen from the results in Table 18, the addition of the necessary amounts of the cobalt and manganese salts to the stripping solutions depending on the solvent extraction/back extraction conditions enabled the production of CMB liquid catalysts. Taking into consideration the fact that the Br concentrations of the stripping solutions were higher than the Br concentration of the CMB specification, the necessary amounts of the cobalt and manganese salts were calculated to be 0.34 mol and 1.04 mol, respectively, as for the stripping solution having a Br concentration of 2.18 mol, and to be 0.37 mol and 0.83 mol, respectively, as for the stripping solution having a Br concentration of 2.05 mol.

As is apparent from the foregoing, according to the present invention, high-purity cobalt and manganese can be recovered in high yield from a spent CMB catalyst while minimizing the amount of impurities. In addition, a CMB liquid catalyst can be produced from an extract containing the recovered cobalt and manganese.

While the present invention has been described in detail in connection with particular embodiments, it will be apparent to those skilled in the art that these embodiments do not serve to limit the scope of the invention and are set forth for illustrative purposes. Therefore, the substantial scope of the present invention should be defined by the attached claims and their equivalents.

1. A method for recovering cobalt and manganese from a spent cobalt-manganese-bromine (CMB) catalyst, the method comprising:
(a) continuously leaching a spent CMB catalyst with sulfuric acid;
(b) separating the leachate into a solution and a residue;
(c) extracting the solution with a solvent; and
(d) washing the extract with water.

2. The method according to claim 1, wherein the continuous leaching is carried out to remove one or more impurities selected from the group consisting of Fe, Pb, Cu and Zn.

3. The method according to claim 1, wherein the solvent is selected from the group consisting of di-2-ethylhexyl phosphoric acid, 2-ethylhexyl phosphonic acid, mono-2-ethylhexyl ester, di-2,4,4-trimethylpentyl phosphinic acid, di-2-ethylhexyl phosphinic acid, di-2,4,4-trimethylpentyl dithiophosphinic acid, di-2,4,4-trimethylpentyl monothiophosphinic acid, and mixtures thereof.

4. The method according to claim 3, wherein the solvent is saponified with an alkaline solution before use.

5. The method according to claim 4, wherein the degree of saponification of the solvent is from 30 to 50%.

6. A method for producing a cobalt-manganese-bromine (CMB) liquid catalyst from a spent CMB catalyst, the method comprising:
(e) adding a hydrobromic acid (HBr) solution to the extract obtained in the method according to claim 1, followed by back extraction to obtain a CMB stripping solution; and
(f) adding a cobalt salt and a manganese salt to the CMB stripping solution to produce a CMB liquid catalyst having appropriate cobalt, manganese and bromine concentrations.

7. The method according to claim 6, wherein the extract used in step (e) is one obtained step (c) extracting the solution with a solvent or step (d) washing the extract with water.
